(19) United States
(12) Patent Application Publication
(10) Pub. No.: US 2026/0229707 A1
(43) Pub. Date: Aug. 6, 2026

(54) SECONDARY BATTERY AND ELECTRONIC APPARATUS

(71) Applicant: Dongguan Amperex Technology Limited, Dongguan (CN)

(72) Inventors: Dekai FANG, Dongguan (CN); Zhi Chen, Dongguan (CN)

(73) Assignee: Dongguan Amperex Technology Limited, Dongguan (CN)

(21) Appl. No.: 19/635,052

(22) Filed: Mar. 31, 2026

Related U.S. Application Data
(63) Continuation of application No. PCT/CN2024/135216, filed on Nov. 28, 2024.

(30) Foreign Application Priority Data
Dec. 29, 2023 (CN) 202311873728.0

(51) Int. Cl. H01M 50/46; H01M 4/13; H01M 50/119; H01M 50/121; H01M 50/124; H01M 50/42; H01M 50/426

(52) U.S. Cl. CPC H01M 50/461; H01M 4/13; H01M 50/119; H01M 50/121; H01M 50/124; H01M 50/42; H01M 50/426

(57) ABSTRACT

A secondary battery including a housing and an electrode assembly, where the housing accommodates the electrode assembly and the electrode assembly is configured to be curved in a first direction. The electrode assembly includes a cathode electrode plate, a separator, and an anode electrode plate arranged in a stacked manner, where the separator includes a first surface and a second surface oppositely disposed along the first direction. The separator includes a first adhesive layer disposed on the first surface and a second adhesive layer disposed on the second surface, the first adhesive layer adhering to the anode electrode plate and the second adhesive layer adhering to the cathode electrode plate. A peel strength between the first adhesive layer and the anode electrode plate is S₁ and a peel strength between the second adhesive layer and the cathode electrode plate is S₂, satisfying S₁<S₂.

### CROSS-REFERENCE TO RELATED APPLICATION

This application is a continuation application of International Patent Application Serial Number PCT/CN2024/135216, filed on Nov. 28, 2024, which claims priority to Chinese Patent Application Serial Number 202311873728.0. filed on Dec. 29, 2023, the contents of which are incorporated herein by reference in their entireties.

### TECHNICAL FIELD

The present application relates to the field of energy storage technology, and in particular, to a secondary battery and an electronic apparatus.

### BACKGROUND

As the application scenarios of electronic apparatuses become increasingly complex, to meet usage demands, the types of electronic apparatuses are becoming more diverse. Nowadays, wearable electronic apparatuses have become popular, and to adapt to the battery compartments of wearable electronic apparatuses, secondary batteries need to be designed with a curved or arc-shaped structure.

The electrode assembly within a secondary battery having a curved or arc-shaped structure is correspondingly curved or arc-shaped. However, after the electrode assembly is processed to be curved, the active material particles on the electrode plates in the electrode assembly are subjected to compression or stretching, leading to stress relaxation, which easily causes deformation or rebound of the electrode plates, resulting in issues such as reduced curvature or flattening of the secondary battery.

### SUMMARY

In view of this, the present application provides a secondary battery and an electronic apparatus, which are beneficial to addressing the issues of reduced curvature and flattening deformation in secondary batteries.

According to a first aspect of the present application, a secondary battery is provided, the secondary battery including a housing and an electrode assembly. The electrode assembly is accommodated in the housing, and the electrode assembly is configured to be curved in a first direction. The electrode assembly includes a cathode electrode plate, a separator, and an anode electrode plate arranged in a stacked manner, where the separator includes a first surface and a second surface oppositely disposed along the first direction. The separator includes a first adhesive layer disposed on the first surface and a second adhesive layer disposed on the second surface, the first adhesive layer adhering to the anode electrode plate and the second adhesive layer adhering to the cathode electrode plate. A peel strength between the first adhesive layer and the anode electrode plate is S₁ and a peel strength between the second adhesive layer and the cathode electrode plate is S₂, satisfying S₁<S₂.

In the above embodiment, by satisfying S₁<S₂, the peel strength between the separator and the cathode electrode plate can be increased, which is beneficial to restricting deformation of the cathode electrode plate and suppressing rebound of the electrode plate, while ensuring that the peel strength between the separator and the anode electrode plate is not excessively high, thereby facilitating a reduction in the risk of separator pore clogging.

In one or more of the above embodiments, a surface of the anode electrode plate is provided with a plurality of first protrusions.

In the above embodiment, providing the plurality of first protrusions on the anode electrode plate, which is more prone to deformation, is beneficial to dispersing stress in the anode electrode plate, facilitating suppression of deformation and rebound of the anode electrode plate while reducing the risk of separator pore clogging. This helps maintain the shape of the electrode assembly after curving, thereby addressing the issues of reduced curvature and flattening deformation in the entire secondary battery, and improving the performance and reliability of the secondary battery.

In one or more of the above embodiments, 1.6S₁≤S₂≤4S₁ is satisfied.

In the above embodiment, satisfying the condition 1.6S₁≤S₂≤4S₁ is beneficial to suppressing deformation of the electrode assembly after curving and reducing the risk of separator pore clogging, thereby reducing internal resistance and improving the electrochemical performance of the secondary battery.

In one or more of the above embodiments, 6 N/m≤S₁<9.6 N/m is satisfied.

In the above embodiment, satisfying the condition 6 N/m≤S₁<9.6 N/m is beneficial to suppressing deformation of the electrode assembly after curving and reducing the risk of separator pore clogging, thereby reducing internal resistance and improving the electrochemical performance of the secondary battery.

In one or more of the above embodiments, 9.6 N/m≤S₂≤15 N/m is satisfied.

In the above embodiment, satisfying the condition 9.6 N/m≤S₂≤15 N/m is beneficial to suppressing deformation of the electrode assembly after curving and reducing the risk of separator pore clogging, thereby reducing internal resistance and improving the electrochemical performance of the secondary battery.

In one or more of the above embodiments, a surface of the anode electrode plate facing away from the plurality of first protrusions is provided with a plurality of first recesses, and along the first direction, an orthographic projection of the first protrusion overlaps with an orthographic projection of one of the first recesses.

In the above embodiment, both the first protrusions and the first recesses can disperse stress in the curved anode electrode plate, further facilitating suppression of deformation and rebound of the anode electrode plate, thereby further addressing the issues of reduced curvature and flattening deformation in the electrode assembly and the entire secondary battery. Additionally, the overlap of the orthographic projections of the first protrusion and the first recess facilitates simultaneous formation of the first protrusion and the first recess, thereby improving the processing efficiency of the first protrusions and first recesses.

In one or more of the above embodiments, a surface of the cathode electrode plate is provided with a plurality of second protrusions and a surface of the cathode electrode plate facing away from the plurality of second protrusions is provided with a plurality of second recesses. Along the first direction, an orthographic projection of the second protrusion overlaps with an orthographic projection of the second recess.

In the above embodiment, both the second protrusions and the second recesses can disperse stress in the curved cathode electrode plate, further facilitating suppression of deformation and rebound of the cathode electrode plate, and facilitating simultaneous formation of the second protrusions and the second recesses, thereby improving the processing efficiency of the second protrusions and second recesses.

In one or more of the above embodiments, a shape of the first protrusion is one of a dotted protrusion, a textured protrusion, or a striped protrusion.

In the above embodiment, the first protrusion having the shape of a dotted protrusion, textured protrusion, or striped protrusion is beneficial to dispersing stress on the anode electrode plate and increasing friction between the anode electrode plate and the cathode electrode plate, thereby facilitating suppression of deformation and rebound of the anode electrode plate.

In one or more of the above embodiments, a shape of the second protrusion is one of a dotted protrusion, a textured protrusion, or a striped protrusion.

In the above embodiment, the second protrusion having the shape of a dotted protrusion, textured protrusion, or striped protrusion is beneficial to dispersing stress on the cathode electrode plate and increasing friction between the anode electrode plate and the cathode electrode plate, thereby facilitating suppression of deformation and rebound of the cathode electrode plate.

In one or more of the above embodiments, in a flattened state of the anode electrode plate, when viewed along the first direction, a sum of areas of the plurality of first protrusions is M₁ and an area of the anode electrode plate is M₂, satisfying: 0.06M₂≤M₁<M₂.

In the above embodiment, satisfying the condition 0.06M₂≤M₁<M₂ is beneficial to enhancing the stress dispersion effect of the plurality of first protrusions on the overall stress of the anode electrode plate, thereby improving the suppression of deformation of the first electrode plate after curving.

In one or more of the above embodiments, along the first direction, the anode electrode plate includes a first current collector and a first active material layer arranged in a stacked manner, the first current collector includes a first coated region, both sides of the first coated region are provided with the first active material layer, a thickness of the anode electrode plate corresponding to the first coated region is T₁, and a height of the first protrusion is H₁, satisfying H₁≤0.1T₁.

In the above embodiment, satisfying the condition H₁≤0.1T₁ is beneficial to enhancing the stress dispersion effect of the first protrusion on the anode electrode plate, thereby further suppressing deformation of the curved anode electrode plate. In embodiments where the first protrusion is formed by an embossing roller, satisfying this condition also helps reduce the risk of damage to the anode electrode plate due to excessive pressure from the embossing roller or excessive local deformation of the anode electrode plate.

In one or more of the above embodiments, in the flattened state of the anode electrode plate, the anode electrode plate has a first boundary line and a second boundary line oppositely disposed along a second direction, and a third boundary line and a fourth boundary line oppositely disposed along a third direction, where the first direction, the second direction, and the third direction are pairwise perpendicular.

In one or more of the above embodiments, a minimum distance between the plurality of first protrusions and the first boundary line is L₁, and a minimum distance between the plurality of first protrusions and the second boundary line is L₂, satisfying 1 mm≤L₁≤7 mm and 1 mm≤L₂≤7 mm.

In the above embodiment, satisfying the above conditions is beneficial to reducing the risk of the embossing roller pressing on the cut edge of the anode electrode plate in the second direction, thereby reducing the risk of damage to the anode electrode plate.

In one or more of the above embodiments, a minimum distance between a first region and the third boundary line is L₃ and a minimum distance between the first region and the fourth boundary line is L₄, satisfying 1 mm≤L₃≤7 mm and 1 mm≤L₄≤7 mm.

In the above embodiment, satisfying the above conditions is beneficial to reducing the risk of the embossing roller pressing on the cut edge of the anode electrode plate in the third direction, thereby reducing the risk of damage to the anode electrode plate.

In one or more of the above embodiments, a distance between any two adjacent first protrusions are F₁, satisfying 1.5 mm≤F₁≤3 mm.

In the above embodiment, satisfying the condition 1.5 mm≤F₁≤3 mm is beneficial to dispersing stress in the anode electrode plate, further suppressing deformation of the curved anode electrode plate and preventing the electrode assembly from easily developing dark spots.

In one or more of the above embodiments, when viewed along the first direction, a width of the first protrusion is R₁, satisfying R₁≥1 mm.

In the above embodiment, satisfying the condition R₁≥1 mm is beneficial to enhancing the stress dispersion effect of the first protrusion on the anode electrode plate, thereby further suppressing deformation of the curved anode electrode plate, and preventing the electrode assembly from easily developing dark spots.

In one or more of the above embodiments, along the first direction, the anode electrode plate, the separator, and the cathode electrode plate are sequentially stacked to form a laminated structure, and in the first direction, the outermost layers of the electrode assembly are both cathode electrode plates.

In the above embodiment, by configuring the outermost layers as the cathode electrode plate, the outermost cathode electrode plate can adhere to the second adhesive layer, which is beneficial to suppressing rebound of the outermost cathode electrode plate, maintaining the shape of the electrode assembly after curving, thereby addressing the issues of reduced curvature and flattening deformation in the entire secondary battery, and improving the performance and reliability of the secondary battery.

In one or more of the above embodiments, the housing is an aluminum-plastic film packaging bag.

In one or more of the above embodiments, the first adhesive layer includes a first adhesive and the second adhesive layer includes a second adhesive, where the first adhesive and the second adhesive are each independently selected from one or a combination of polyvinylidene fluoride, vinylidene fluoride-hexafluoropropylene copolymer, polyamide, polyacrylonitrile, polyacrylate, polyacrylic acid, polyacrylate salt, polyvinylpyrrolidone, polyvinyl ether, polymethyl methacrylate, polytetrafluoroethylene, and polyhexafluoropropylene.

In one or more of the above embodiments, the first adhesive and the second adhesive are of a same type and a content of the second adhesive in the second adhesive layer is greater than a content of the first adhesive in the first adhesive layer.

In the above embodiment, the content of the second adhesive in the second adhesive layer being greater than the content of the first adhesive in the first adhesive layer is beneficial to achieving the peel strength between the second adhesive layer and the cathode electrode plate greater than the peel strength between the first adhesive layer and the anode electrode plate.

In one or more of the above embodiments, the first adhesive layer includes polyvinylidene fluoride, with a content of polyvinylidene fluoride in the first adhesive layer being 3 mg/5000 mm² to 4 mg/5000 mm² and a content of polyvinylidene fluoride in the first adhesive layer being 60 wt % to 80 wt %.

In the above embodiment, the specific configuration of the first adhesive layer ensures that the peel strength between the first adhesive layer of the separator and the electrode plate is above 6 N/m, which is beneficial to suppressing deformation of the electrode assembly after curving.

In one or more of the above embodiments, the second adhesive layer includes acrylate, with a content of acrylate in the second adhesive layer being 0.7 mg/5000 mm² to 1.1 mg/5000 mm² and a content of acrylate in the second adhesive layer being 85 wt % to 95 wt %.

In the above embodiment, the specific configuration of the second adhesive layer ensures that the peel strength between the second adhesive layer of the separator and the electrode plate is above 10 N/m, which is beneficial to suppressing deformation of the electrode assembly after curving.

According to a second aspect of the present application, an electronic apparatus is provided, including the secondary battery according to any one of the above embodiments.

In the above embodiment, the issue of flattening deformation in the secondary battery is alleviated, which is beneficial to improving the reliability of the secondary battery in use, thereby facilitating a reduction in the reserved space for the battery compartment in the electronic apparatus and improving the reliability of the electronic apparatus in use.

The electrode assembly of the secondary battery in the present application is configured to be curved in a first direction. The electrode assembly includes a cathode electrode plate, a separator, and an anode electrode plate arranged in a stacked manner, where the separator includes a first surface and a second surface oppositely disposed along the first direction. The separator includes a first adhesive layer disposed on the first surface and a second adhesive layer disposed on the second surface, the first adhesive layer adhering to the anode electrode plate, and the second adhesive layer adhering to the cathode electrode plate. A peel strength between the first adhesive layer and the anode electrode plate is S₁ and a peel strength between the second adhesive layer and the cathode electrode plate is S₂, satisfying S₁<S₂. By satisfying S₁<S₂, the peel strength between the separator and the cathode electrode plate can be increased, which is beneficial to restricting deformation of the cathode electrode plate and suppressing rebound of the electrode plate, while ensuring that the peel strength between the separator and the anode electrode plate is not excessively high, thereby facilitating a reduction in the risk of separator pore clogging.

### BRIEF DESCRIPTION OF DRAWINGS

FIG. 1 is a cross-sectional view of a secondary battery provided in one embodiment of the present application.

FIG. 2 is a cross-sectional view of a secondary battery provided in another embodiment of the present application.

FIG. 3 is a cross-sectional view of an anode electrode plate, a cathode electrode plate, and a separator provided in one embodiment of the present application.

FIG. 4 is a cross-sectional view of a secondary battery provided in one embodiment of the present application.

FIG. 5 is a cross-sectional view of an anode electrode plate provided in one embodiment of the present application.

FIG. 6 is a cross-sectional view of a cathode electrode plate provided in one embodiment of the present application.

FIG. 7 is a schematic diagram of an anode electrode plate in an unfolded state provided in one embodiment of the present application.

FIG. 8 is a schematic diagram of an anode electrode plate in an unfolded state provided in another embodiment of the present application.

FIG. 9 is a schematic diagram of an anode electrode plate in an unfolded state provided in yet another embodiment of the present application.

FIG. 10 is a schematic diagram of a cathode electrode plate in an unfolded state provided in one embodiment of the present application.

FIG. 11 is a schematic diagram of a cathode electrode plate in an unfolded state provided in another embodiment of the present application.

FIG. 12 is a schematic diagram of a cathode electrode plate in an unfolded state provided in yet another embodiment of the present application.

FIG. 13 is a schematic diagram of an electronic apparatus provided in one embodiment of the present application.

### DESCRIPTION OF REFERENCE SIGNS OF MAIN COMPONENTS

| | |
|---|---|
| Secondary battery | 100 |
| Housing | 10 |
| Electrode assembly | 20 |
| Electrode plate | 21 |
| Anode electrode plate | 211 |
| First current collector | 2111 |
| First side | 211a |
| Second side | 211b |
| First coated region | 211c |
| First active material layer | 2112 |
| First protrusion | 2113 |
| First recess | 2114 |
| First boundary line | 21a |
| Second boundary line | 21b |
| Third boundary line | 21c |
| Fourth boundary line | 21d |
| Cathode electrode plate | 212 |
| Second current collector | 2121 |
| Third side | 212a |
| Fourth side | 212b |
| Second coated region | 212c |
| Second active material layer | 2122 |
| Second protrusion | 2123 |
| Second recess | 2124 |
| Separator | 22 |
| First adhesive layer | 221 |
| Substrate layer | 222 |
| First surface | 2221 |
| Second surface | 2222 |
| Second adhesive layer | 223 |
| Apparatus body | 200 |
| Electronic apparatus | 1000 |
| First direction | X |
| Second direction | Y |
| Third direction | Z |

### DESCRIPTION OF EMBODIMENTS

The technical solutions in the embodiments of the present application will be described below with reference to the drawings in the embodiments of the present application. It is apparent that the described embodiments are only a part of the embodiments of the present application, and not all of the embodiments.

It should be noted that when a component is referred to as being “connected” to another component, it can be directly connected to the other component or there may be an intervening component present. When a component is referred to as being “disposed on” another component, it can be directly disposed on the other component or there may be an intervening component present.

Unless otherwise specified, the term “plurality” as used herein refers to two or more.

The terms “first,” “second,” and the like are used only to distinguish different objects and should not be understood as indicating or implying relative importance, or implying the number, specific order, or priority of the indicated technical features.

The term “perpendicular” is used to describe an ideal state between two components. In actual production or use, there may be an approximate perpendicular state between the two components. For example, when described with numerical values, perpendicular may refer to an angle range between two lines of 90°±10°, or a dihedral angle range between two planes of 90°±10°, or an angle range between a line and a plane of 90°±10°.

It should be noted that when a parameter is greater than, equal to, or less than an endpoint value, it should be understood that the endpoint value allows a tolerance of ±10%. For example, if A is greater than 10 compared to B, it should be understood to include cases where A is greater than 9 compared to B, as well as cases where A is greater than 11 compared to B.

It should be recognized that the dimensions of layers, regions, films, plates, blocks, columns, protrusions, recesses, and the like shown in the drawings are provided for better understanding and ease of description, and the present application is not limited to the dimensions shown in the drawings. To make the present invention clear, elements irrelevant to the description are omitted from the details of this specification.

Unless otherwise defined, all technical and scientific terms used herein have the same meaning as commonly understood by those skilled in the technical field of the present application. The terms used in the specification of the present application herein are for the purpose of describing specific embodiments only and are not intended to limit the present application.

The present application provides a secondary battery including a housing and an electrode assembly. The electrode assembly is accommodated in the housing, and the electrode assembly is configured to be curved in a first direction. The electrode assembly includes a cathode electrode plate, a separator, and an anode electrode plate arranged in a stacked manner, where the separator includes a first surface and a second surface oppositely disposed along the first direction. The separator includes a first adhesive layer disposed on the first surface and a second adhesive layer disposed on the second surface, the first adhesive layer adhering to the anode electrode plate and the second adhesive layer adhering to the cathode electrode plate. A peel strength between the first adhesive layer and the anode electrode plate is S₁ and a peel strength between the second adhesive layer and the cathode electrode plate is S₂, satisfying S₁<S₂.

By satisfying S₁<S₂, the peel strength between the separator and the cathode electrode plate can be increased, which is beneficial to restricting deformation of the cathode electrode plate and suppressing rebound of the electrode plate, while ensuring that the peel strength between the separator and the anode electrode plate is not excessively high, thereby facilitating a reduction in the risk of separator pore clogging.

The following will describe some embodiments of the present application with reference to the accompanying drawings. In the absence of conflict, the embodiments described below and the features in the embodiments can be combined with each other.

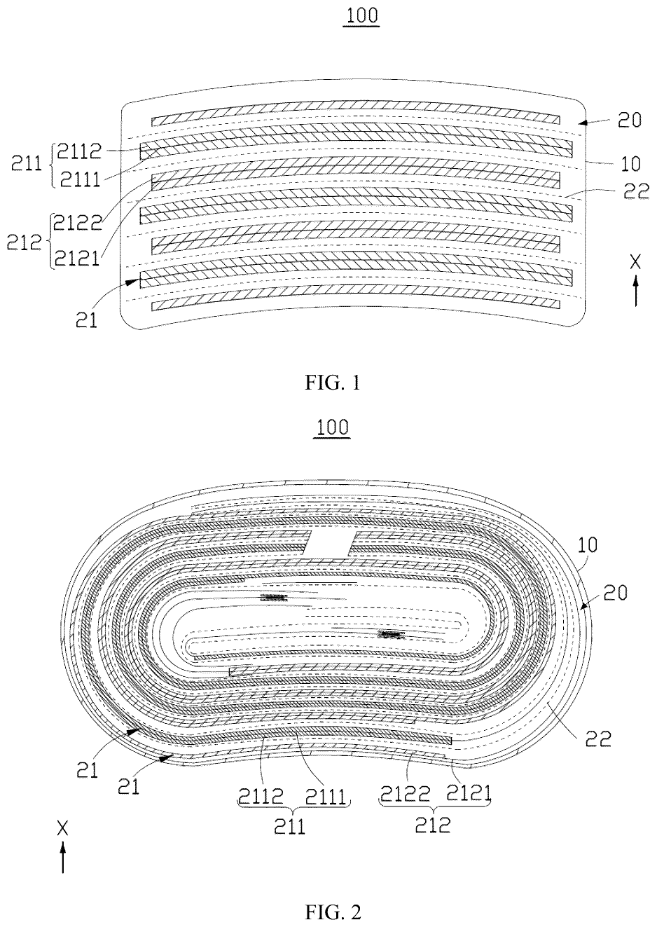

Referring to FIG. 1, an embodiment of the present application provides a secondary battery 100, the secondary battery 100 including a housing 10 and an electrode assembly 20, the electrode assembly 20 being accommodated in the housing 10, and the electrode assembly 20 being configured to be curved in a first direction X. The first direction X is a bending direction of the electrode assembly 20, defined as the direction from the concave side of the electrode assembly 20 after curving to the convex side of the electrode assembly 20 after curving.

In some embodiments, the housing 10 is a flexible packaging bag, such as an aluminum-plastic film. In other embodiments, the housing 10 is a hard shell, such as a plastic shell, or a metal shell including at least one of steel alloy, aluminum alloy, or copper alloy.

In some embodiments, an electrolyte (not shown) can be injected into the housing 10, and the electrolyte components include a solvent, a lithium salt, and additives.

In some embodiments, referring to FIG. 1, the electrode assembly 20 includes multiple layers of electrode plates 21 and multiple layers of separators 22 arranged in a stacked manner, with at least one layer of separator 22 disposed between any two adjacent layers of electrode plates 21, the separator 22 being used to isolate the adjacent two layers of electrode plates 21.

In some embodiments, referring to FIG. 1, the secondary battery 100 is a laminated battery, with the multiple layers of electrode plates 21 and multiple layers of separators 22 stacked along the first direction X, and the multiple layers of electrode plates 21 and multiple layers of separators 22 being configured to be curved along the first direction X.

In other embodiments, referring to FIG. 2, the secondary battery 100 is a wound battery, with the multiple layers of electrode plates 21 and multiple layers of separators 22 stacked and wound to form a wound structure, forming a multilayer structure along the first direction X, and the wound electrode plates 21 and separators 22 being configured to be curved along the first direction X.

In some embodiments, the first direction X is parallel to a thickness direction of the electrode assembly 20.

In some embodiments, referring to FIG. 1 and FIG. 2, the electrode plate 21 includes an anode electrode plate 211 and a cathode electrode plate 212, the anode electrode plate 211 and the cathode electrode plate 212 being stacked along the first direction X, with one of any two adjacent layers of electrode plates 21 being an anode electrode plate 211 and the other being a cathode electrode plate 212, and a separator 22 being disposed between the adjacent anode electrode plate 211 and cathode electrode plate 212, the separator 22 being used to isolate the anode electrode plate 211 and the cathode electrode plate 212.

In some embodiments, the secondary battery 100 is a wound battery, and the electrode assembly 20 has two curved segments (not labeled) disposed along the second direction Y and an intermediate segment (not labeled) located between the curved segments, where the second direction Y is perpendicular to the first direction X. The multiple layers of cathode electrode plates 212, multiple layers of anode electrode plates 211, and multiple layers of separators 22 in the intermediate segment are generally arranged along the first direction X, and the multiple layers of cathode electrode plates 212, multiple layers of anode electrode plates 211, and multiple layers of separators 22 in the curved segments are generally arranged along the second direction Y.

In some embodiments, referring to FIG. 3, the anode electrode plate 211 includes a first current collector 2111 and a first active material layer 2112 arranged in a stacked manner. In a flattened state of the anode electrode plate 211, along a thickness direction of the anode electrode plate 211, the first current collector 2111 has a first side 211a and a second side 211b oppositely disposed. The first current collector 2111 includes a first coated region 211c, where both the first side 211a and the second side 211b of the first coated region 211c are provided with the first active material layer 2112. The first coated region 211c is a double-sided coated region.

In some embodiments, referring to FIG. 3, the cathode electrode plate 212 includes a second current collector 2121 and a second active material layer 2122 arranged in a stacked manner. In a flattened state of the cathode electrode plate 212, along a thickness direction of the cathode electrode plate 212, the second current collector 2121 has a third side 212a and a fourth side 212b oppositely disposed. The second current collector 2121 includes a second coated region 212c, where both the third side 212a and the fourth side 212b of the second coated region 212c are provided with the second active material layer 2122. The second coated region 212c is a double-sided coated region.

In some embodiments, the first current collector 2111 and the second current collector 2121 may be metal layers. The first current collector 2111 may be a metal layer including at least one of copper, nickel, tantalum, or titanium, such as a copper foil. The second current collector 2121 may be a metal layer including at least one of aluminum, nickel, tantalum, or titanium, such as an aluminum foil.

In some embodiments, the polarity of the first active material layer 2112 is anode, and the first active material layer 2112 includes an anode active material, where the anode active material may include at least one of graphite, hard carbon, soft carbon, silicon, silicon-oxygen material, or silicon-carbon material. The polarity of the second active material layer 2122 is cathode, and the second active material layer 2122 includes a cathode active material, where the cathode active material may include at least one of lithium cobalt oxide, lithium nickel cobalt manganese oxide, lithium nickel cobalt aluminum oxide, lithium iron phosphate, lithium manganese iron phosphate, or lithium manganese oxide.

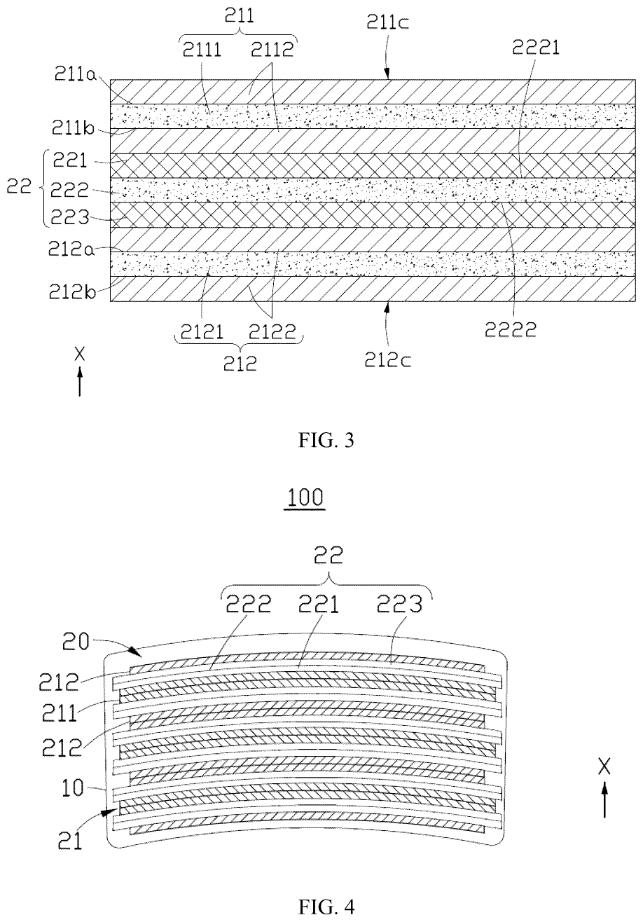

In some embodiments, referring to FIG. 3 and FIG. 4, the separator 22 includes a substrate layer 222, where the substrate layer 222 has a first surface 2221 and a second surface 2222 oppositely disposed along the first direction X. The separator further includes a first adhesive layer 221 disposed on the first surface 2221 and a second adhesive layer 223 disposed on the second surface 2222, where the first adhesive layer 221 adheres to the anode electrode plate 211 and the second adhesive layer 223 adheres to the cathode electrode plate 212.

In some embodiments, the substrate layer 222 is selected from at least one of polyolefin, polyvinylidene fluoride, polyethylene terephthalate, cellulose, polyimide, polyamide, spandex, or polyparaphenylene terephthalamide. The substrate layer 222 is a microporous and porous film capable of allowing ion passage and retaining electrolyte functionality.

In some embodiments, the first adhesive layer 221 is provided with a first adhesive and the second adhesive layer 223 is provided with a second adhesive. The first adhesive and the second adhesive are each independently selected from one or a combination of polyvinylidene fluoride, vinylidene fluoride-hexafluoropropylene copolymer, polyamide, polyacrylonitrile, polyacrylate, polyacrylic acid, polyacrylate salt, polyvinylpyrrolidone, polyvinyl ether, polymethyl methacrylate, polytetrafluoroethylene, and polyhexafluoropropylene.

A peel strength between the first adhesive layer 221 and the anode electrode plate 211 is S₁ and a peel strength between the second adhesive layer 223 and the cathode electrode plate 212 is S₂, satisfying S₁<S₂.

By configuring the first adhesive layer 221 and the second adhesive layer 223 to satisfy the condition S₁<S₂, the peel strength between the separator 22 and the cathode electrode plate 212 can be increased, which is beneficial to restricting deformation of the cathode electrode plate 212 and suppressing rebound of the electrode plate 21. Additionally, ensuring that the peel strength between the separator and the anode electrode plate 211 is not excessively high facilitates reducing the risk of separator 22 pore clogging, thereby reducing internal resistance and improving the chemical performance of the secondary battery 100.

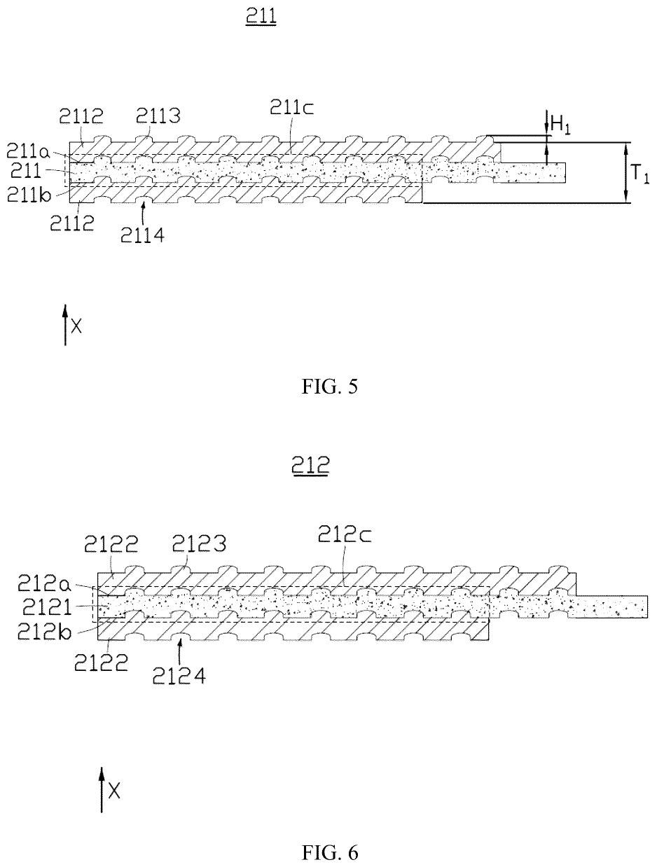

In some embodiments, referring to FIG. 5, a surface of the anode electrode plate 211 is provided with a plurality of first protrusions 2113.

Research has found that the anode electrode plate 211 is more prone to rebound compared to the cathode electrode plate 212. By providing the plurality of first protrusions 2113 on the anode electrode plate 211, which is more susceptible to deformation, it is beneficial to dispersing stress in the anode electrode plate 211, thereby suppressing deformation and rebound of the anode electrode plate 211 while reducing the risk of separator 22 pore clogging. This helps maintain the shape of the electrode assembly 20 after curving, addressing the issues of reduced curvature and flattening deformation in the entire secondary battery 100, and improving the performance and reliability of the secondary battery 100.

In some embodiments, 1.6S₁≤S₂≤4S₁ is satisfied, which is beneficial to suppressing deformation of the electrode assembly 20 after curving and reducing the risk of separator 22 pore clogging, thereby reducing internal resistance and improving the electrochemical performance of the secondary battery 100.

As an exemplary illustration, S₂ may specifically be 1.6S₁, 2S₁, 2.4S₁, 2.8S₁, 3.2S₁, 3.6S₁, or 4S₁.

In some embodiments, 6 N/m≤S₁<9.6 N/m is satisfied, which is beneficial to suppressing deformation of the electrode assembly 20 after curving and reducing the risk of separator 22 pore clogging, thereby reducing internal resistance and improving the electrochemical performance of the secondary battery 100.

As an exemplary illustration, S₁ may specifically be 6 N/m, 6.2 N/m, 6.6 N/m, 6.8 N/m, 7 N/m, 7.2 N/m, 7.6 N/m, 7.8 N/m, 8 N/m, 8.2 N/m, 8.6 N/m, 8.8 N/m, 9 N/m, or 9.5 N/m.

In some embodiments, 9.6 N/m≤S₂≤15 N/m is satisfied, which is beneficial to suppressing deformation of the electrode assembly 20 after curving and reducing the risk of separator 22 pore clogging, thereby reducing internal resistance and improving the electrochemical performance of the secondary battery 100.

As an exemplary illustration, S₂ may specifically be 9.6 N/m, 10 N/m, 10.2 N/m, 10.6 N/m, 10.8 N/m, 11 N/m, 11.2 N/m, 11.6 N/m, 11.8 N/m, 12 N/m, 12.2 N/m, 12.6 N/m, 12.8 N/m, 13 N/m, 13.2 N/m, 13.6 N/m, 13.8 N/m, 14 N/m, 14.2 N/m, 14.6 N/m, 14.8 N/m, or 15 N/m.

In some embodiments, the first adhesive and the second adhesive may be of a same type and a content of the second adhesive in the second adhesive layer 223 is greater than a content of the first adhesive in the first adhesive layer 221, thereby making the peel strength S₂ between the second adhesive layer 223 and the cathode electrode plate 212 greater than the peel strength S₁ between the first adhesive layer 221 and the anode electrode plate 211.

The first adhesive may be selected from one or a combination of polyvinylidene fluoride, vinylidene fluoride-hexafluoropropylene copolymer, polyamide, polyacrylonitrile, polyacrylate, polyacrylic acid, polyacrylate salt, polyvinylpyrrolidone, polyvinyl ether, polymethyl methacrylate, polytetrafluoroethylene, and polyhexafluoropropylene. The second adhesive may be selected from one or a combination of polyvinylidene fluoride, vinylidene fluoride-hexafluoropropylene copolymer, polyamide, polyacrylonitrile, polyacrylate, polyacrylic acid, polyacrylate salt, polyvinylpyrrolidone, polyvinyl ether, polymethyl methacrylate, polytetrafluoroethylene, and polyhexafluoropropylene.

Taking the first adhesive as polyvinylidene fluoride (PVDF) as an example, given that the crystalline region of PVDF is a semi-crystalline region with a distinct melting peak at 140° C.-150° C., a content of PVDF can be estimated based on its melting peak. Specifically, the method for measuring the PVDF content may include the following steps:
(1) Separate the first adhesive layer 221 from the separator 22 to obtain an agglomerated powder with a mass of M.
(2) Use a Mettler differential scanning calorimeter DSC to test the melting peak of the agglomerated powder with a mass of M, and integrate the melting peak at 140° C.-150° C. to obtain the heat E absorbed by PVDF during melting.
(3) Calculate the mass M1 of PVDF, where M1=E/(Hm×η), with Hm being the melting enthalpy of fully crystalline PVDF at 104.7 J/g, and η being the crystallinity of PVDF at 49.5%.

When the second adhesive is PVDF, the same method can be used to measure its content. It can be understood that when other materials are used for the adhesive layers, the measurement method for the content can be correspondingly set based on the properties of the adhesive.

In some embodiments, referring to FIG. 4, along the first direction X, the anode electrode plate 211, the separator 22, and the cathode electrode plate 212 are sequentially stacked to form a laminated structure, and the outermost layers of the electrode assembly 20 are both cathode electrode plates 212. The first adhesive layer 221 and the second adhesive layer 223 are sequentially disposed along the first direction X.

Research has found that in a curved electrode assembly 20, the electrode plate 21 closer to the convex side of the electrode assembly 20 experiences greater stress and is more prone to deformation and rebound. When the outermost side in the opposite two sides of the electrode assembly 20 in the first direction X is the cathode electrode plate 212, the outermost cathode electrode plate 212 on the convex side of the electrode assembly 20 in the first direction X is more likely to rebound. By configuring the outermost layer as the cathode electrode plate 212, the outermost cathode electrode plate 212 can adhere to the second adhesive layer 223, which is beneficial to suppressing rebound of the outermost cathode electrode plate 212, maintaining the shape of the electrode assembly 20 after curving, thereby addressing the issues of reduced curvature and flattening deformation in the entire secondary battery 100, and improving the performance and reliability of the secondary battery 100.

In some embodiments, the first adhesive layer 221 includes polyvinylidene fluoride, with a content of polyvinylidene fluoride in the first adhesive layer 221 being 3 mg/5000 mm² to 4 mg/5000 mm² and a content of polyvinylidene fluoride in the first adhesive layer 221 being 60 wt % to 80 wt %.

In this embodiment, the specific configuration of the first adhesive layer 221 ensures that the peel strength between the first adhesive layer 221 of the separator 22 and the electrode plate 21 is above 6 N/m, which is beneficial to suppressing deformation of the electrode assembly 20 after curving.

It should be noted that the unit “mg/mm²” is the dimension for coating weight, and the coating weight of polyvinylidene fluoride in the first adhesive layer 221 being 3 mg/5000 mm² to 4 mg/5000 mm² means that for every 5000 mm² area of the separator 22, the coating weight of polyvinylidene fluoride is 3 mg to 4 mg.

The unit “wt %” represents mass percentage (%), and the content of polyvinylidene fluoride in the first adhesive layer 221 being 60 wt % to 80 wt % means that the percentage of the mass of polyvinylidene fluoride in the first adhesive layer 221 of the separator 22 relative to the total mass of the first adhesive layer 221 is 60% to 80%. The specific conversion method is: mass percentage wt %=(mass of polyvinylidene fluoride/mass of the first adhesive layer 221)×100%.

In some embodiments, the second adhesive layer 223 includes acrylate, with a content of acrylate in the second adhesive layer 223 being 0.7 mg/5000 mm² to 1.1 mg/5000 mm² and a content of acrylate in the second adhesive layer 223 being 85 wt % to 95 wt %.

In this embodiment, the specific configuration of the second adhesive layer 223 ensures that the peel strength between the second adhesive layer 223 of the separator 22 and the electrode plate 21 is above 10 N/m, which is beneficial to suppressing deformation of the electrode assembly after curving.

It should be noted that the test for the peel strength between the separator 22 and the electrode plate 21 is as follows:

According to GB/T 2792-2014 “Test Method for Peel Strength of Adhesive Tapes,” the peel strength between the separator and the electrode plate is tested using a high-speed tensile testing machine (in embodiments of the present application, the peel strength between the separator 22 and the electrode plate 21 is taken as an example). The testing process is as follows: The lithium-ion battery was discharged to 0 V, then disassembled. The separator 22 together with the electrode plate 21 adhered to it was removed as a single unit, and the surface electrolyte was wiped off with dust-free paper. The sample was then cut into strip-shaped specimens of 20 mm×60 mm. Along the length direction of the specimen, the side of the electrode assembly 20 in the specimen was adhered to a steel plate using double-sided tape (Nitto 5000NS), with an adhesion length of no less than 40 mm. The steel plate was fixed at the corresponding position of the high-speed tensile testing machine, and the other end of the electrode plate 21 that was not adhered to the separator 22 in the specimen was pulled up and clamped in the chuck, such that the pulled-up portion of the specimen formed a 180° angle with the steel plate in space. The chuck pulled the specimen at a speed of 5±0.2 mm/s, and the average tensile force in the stable region was recorded as the peel strength between the separator 22 and the electrode plate 21, denoted as S, with the unit N/m.

When the separator 22 in the sample was adhered to the electrode plate 21 through the first adhesive layer 221, the measured peel strength was the peel strength between the first adhesive layer 221 and the electrode plate 21, denoted as S₁. When the separator 22 in the sample was adhered to the electrode plate 21 through the second adhesive layer 223, the measured peel strength was the peel strength between the second adhesive layer 223 and the electrode plate 21, denoted as S₂.

To verify the impact of the peel strength between the electrode plate 21 and the separator 22 on the reduction of curvature and flattening deformation of the secondary battery 100, the following experiment was conducted:

A comparative test of cyclic charge-discharge was performed on the secondary battery 100. The secondary battery 100 was placed in a constant temperature environment of 25° C., charged at a constant current rate of 0.5C (where 1C represents the current that fully charges the battery in 1 hour) to the full charge voltage, charged at constant voltage until the current reached 0.05C, and then fully discharged at a constant current of 0.5C to 3.0 V, completing one charge-discharge cycle. After 800 cycles of charge-discharge, the radius of curvature change rate and the capacity retention rate of the secondary battery 100 were tested.

The capacity retention rate is calculated as: capacity retention rate=discharge capacity of the N-th cycle (mAh)/initial discharge capacity of the first cycle (mAh).

The radius of curvature change rate of the secondary battery 100 was obtained as follows:

The initial radius of curvature was obtained as follows: before the secondary battery 100 underwent cycle testing, a 3D profilometer was used to scan the 3D structure of the surface of the secondary battery 100. The scanned surface was then averaged to obtain one arc line, three points on the arc line were selected to fit a standard arc line, and the radius of curvature a was read.

The radius of curvature after cycling was obtained as follows: after the secondary battery 100 completed the charge-discharge cycle test, a 3D profilometer was used to scan the 3D structure of the surface of the secondary battery 100. The scanned surface was then averaged to obtain one arc line, three points on the arc line were selected to fit a standard arc line, and the radius of curvature b was read.

The radius of curvature change rate of the secondary battery 100 was calculated as (b−a)/a.

The principle for selecting points is: the arc line fitted by the points should, as much as possible, coincide with the arc line obtained after surface averaging, and points near the endpoints should be excluded.

It should be noted that when the risk of separator 22 pore clogging is reduced, the capacity retention rate of the secondary battery 100 is higher, and the electrochemical performance of the secondary battery 100 is better.

The radius of curvature change rate and the capacity retention rate of all tested secondary batteries 100 are statistically analyzed. If the radius of curvature change rate is less than 9% and the capacity retention rate is greater than 85%, the test is deemed passed; otherwise, it is deemed failed.

The specific embodiments of the secondary battery 100 in the examples and comparative examples are described below.

### EXAMPLES AND COMPARATIVE EXAMPLES

A secondary battery is assembled as follows:

(1) Preparation of the anode electrode plate 211: The anode active material artificial graphite, conductive carbon black (Super P), and styrene-butadiene rubber (SBR) were mixed in a weight ratio of 96:1.5:2.5. Deionized water was added as a solvent to prepare a slurry with a weight percentage of 70 wt %, which was stirred uniformly. The slurry was evenly coated on one surface of a 10 μm thick anode current collector copper foil, leaving an uncoated foil region at the edge of the copper foil, and dried at 110° C. to obtain an anode electrode plate 211 with a coating thickness of 150 μm coated with the anode active material layer on one side. The above steps were repeated on another surface of the anode electrode plate 211 to obtain an anode electrode plate 211 coated with the anode active material layer on two sides. The anode electrode plate 211 was then placed in a rolling machine for embossing to form a plurality of first protrusions 2113 on a surface on one side of the anode electrode plate 211 and a plurality of first recesses 2114 on a surface on another side of the anode electrode plate 211. Then, excess uncoated foil regions were then removed by laser die-cutting to obtain anode tabs.

(2) Preparation of the cathode electrode plate 212: The cathode active material lithium cobalt oxide (LiCoO₂), conductive carbon black (Super P), and polyvinylidene fluoride (PVDF) were mixed in a weight ratio of 97.5:1.0:1.5. N-methylpyrrolidone (NMP) was added as a solvent to prepare a slurry with a solid content of 75 wt %, which was stirred uniformly. The slurry was evenly coated on one surface of a 12 μm thick cathode current collector aluminum foil, leaving an uncoated foil region at the edge of the aluminum foil, and dried at 90° C. to obtain a cathode electrode plate 212 with a cathode active material layer thickness of 100 μm. The single side-coated cathode electrode plate 212 served as the first outer electrode plate. When preparing other double-sided coated first electrode plates (that is, first inner electrode plates), the above coating steps were repeated on another surface of the aluminum foil. Excess uncoated foil regions were then removed by laser die-cutting to obtain cathode tabs.

(3) Preparation of the electrolyte: In a dry argon atmosphere, ethylene carbonate (EC), ethyl methyl carbonate (EMC), and diethyl carbonate (DEC) were first mixed in a mass ratio of EC:EMC:DEC=30:50:20 to form a base organic solvent. Lithium hexafluorophosphate (LiPF₆) was then added to the base organic solvent, dissolved, and mixed uniformly to obtain an electrolyte with a lithium salt concentration of 1.15 mol/L.

(4) Preparation of the separator 22: A three-layer structured separator 22 was used, which included a first adhesive layer 221, a substrate layer 222, and a second adhesive layer 223 arranged in a stacked manner. The substrate layer 222 was made of polyethylene (PE), the first adhesive layer 221 included a first adhesive, and the second adhesive layer 223 included a second adhesive. The first adhesive layer 221 and the second adhesive layer 223 also included inorganic ceramic particles Al₂O₃.

(5) Preparation of the electrode assembly 20: The cathode electrode plate 212, the separator 22, and the anode electrode plate 211 were stacked, and the stacked structure was subjected to flat hot pressing at a temperature of 80° C. and a pressure of 1.5 MPa for 10 seconds to form the electrode assembly 20 for standby.

(6) Assembly of the electrode assembly 20: A pit-formed aluminum-plastic film was placed in an assembly fixture with the pit facing upward, and the electrode assembly 20 was placed in the pit and pressed tightly by applying external force. Another pit-formed aluminum-plastic film with the pit facing downward was then placed over the electrode assembly 20, and the peripheral edges of the two aluminum-plastic films were heat-sealed by hot pressing to obtain the assembled electrode assembly 20.

(7) Liquid injection and encapsulation: The electrolyte was injected into the assembled electrode assembly 20, and vacuum encapsulation, standing, hot-press formation, and shaping processes were performed to obtain the secondary battery 100.

The main parameter controls and test results for each example and comparative example are shown in Table 1 below:

TABLE 1

| | | Content | | Material | Content | | | Radius of | |
|---|---|---|---|---|---|---|---|---|---|
| Example/ | Material | of first | | of | of second | | Relationship | curvature | Capacity |
| comparative | of first | adhesive | S₁ | second | adhesive | S₂ | between S₁ | change | retention |
| example | adhesive | (wt %) | (N/m) | adhesive | (wt %) | (N/m) | and S₂ | rate | rate |
| Comparative | PVDF | 40 | 4 | PVDF | 40 | 4 | S₁ = S₂ < 6 N/m | 24.0% | 76.0% |
| Example 1 | | | | | | | | | |
| Comparative | PVDF | 40 | 4 | PVDF | 35 | 3 | 6 N/m > S₁ > S₂ | 28.0% | 70.0% |
| Example 2 | | | | | | | | | |
| Comparative | PVDF | 60 | 6 | PVDF | 60 | 6 | S₁ = S₂ = 6 N/m | 18.0% | 84.0% |
| Example 3 | | | | | | | | | |
| Comparative | PVDF | 60 | 6 | PVDF | 40 | 4 | S₂ < S₁ < 9.6 | 19.0% | 83.0% |
| Example 4 | | | | | | | N/m | | |
| Example 1 | PVDF | 60 | 6 | PDDA | 87 | 11 | S₂ = 1.8S₁ | 4.0% | 93.0% |
| Example 2 | PVDF | 70 | 7 | PDDA | 87 | 11 | S₂ = 1.6S₁ | 3.5% | 93.5% |
| Example 3 | PVDF | 80 | 8 | PDDA | 87 | 11 | S₂ = 1.4S₁ | 3.0% | 94.0% |
| Example 4 | PDDA | 85 | 9 | PDDA | 87 | 11 | S₂ = 1.2S₁ | 2.5% | 93.0% |
| Example 5 | PDDA | 87 | 9.6 | PDDA | 87 | 11 | S₂ = 1.1S₁ | 2.0% | 92.0% |
| Example 6 | PDDA | 90 | 10 | PDDA | 87 | 11 | S₂ = 1.1S₁ | 9.0% | 90.0% |
| Example 7 | PVDF | 70 | 7 | PDDA | 80 | 8 | S₂ = 1.1S₁ | 9.0% | 87.0% |
| Example 8 | PVDF | 70 | 7 | PDDA | 82 | 9.6 | S₂ = 1.4S₁ | 4.0% | 93.0% |
| Example 9 | PVDF | 70 | 7 | PDDA | 85 | 10 | S₂ = 1.4S₁ | 3.5% | 93.5% |
| Example 10 | PVDF | 70 | 7 | PDDA | 90 | 12 | S₂ = 1.7S₁ | 2.5% | 93.0% |
| Example 11 | PVDF | 70 | 7 | PDDA | 94 | 14 | S₂ = 2.0S₁ | 2.0% | 93.5% |
| Example 12 | PVDF | 70 | 7 | PDDA | 97 | 15 | S₂ = 2.1S₁ | 1.8% | 94.0% |
| Example 13 | PVDF | 70 | 7 | PDDA | 99 | 16 | S₂ = 2.3S₁ | 1.5% | 89.0% |
| Example 14 | PMMA | 80 | 7 | PVDF- | 73 | 11 | S₂ = 1.6S₁ | 3.5% | 93.5% |
| | | | | HFP | | | | | |

Here, PVDF is polyvinylidene fluoride, PDDA is acrylate, PVDF-HFP is vinylidene fluoride-hexafluoropropylene copolymer, and PMMA is polymethyl methacrylate.

According to Table 1 above, compared to Comparative Examples 1-4, Example 1 satisfies S₁<S₂, which is beneficial to suppressing deformation of the secondary battery 100 after curving, addressing the issues of reduced curvature and flattening deformation in the secondary battery 100, and improving the capacity retention rate of the secondary battery 100, thereby enhancing the chemical performance of the secondary battery 100.

According to Table 1 above, compared to Comparative Example 1 and Example 6, Examples 1-5 satisfy the condition 6 N/m≤S₁<9.6 N/m, which is beneficial to suppressing deformation of the electrode assembly after curving and reducing the risk of separator pore clogging, thereby reducing internal resistance and improving the electrochemical performance of the secondary battery.

According to Table 1 above, compared to Examples 7 and 13, Examples 2 and 8-12 satisfy the condition 9.6 N/m≤S₂≤15 N/m, which is beneficial to suppressing deformation of the secondary battery 100 after curving, addressing the issues of reduced curvature and flattening deformation in the secondary battery 100, and improving the capacity retention rate of the secondary battery 100, thereby enhancing the chemical performance of the secondary battery 100.

In some embodiments, referring to FIG. 5, a surface of the anode electrode plate 211 is provided with a plurality of first protrusions 2113. The first protrusions 2113 can disperse stress in the curved anode electrode plate 211, suppressing deformation and rebound of the anode electrode plate 211, which is beneficial to maintaining the shape of the anode electrode plate 211 after curving and addressing the issues of reduced curvature and flattening deformation in the entire electrode assembly 20. When the overall curvature of the electrode assembly 20 remains substantially unchanged, the secondary battery 100 does not undergo significant deformation, thereby facilitating the resolution of issues of reduced curvature and flattening deformation in the secondary battery 100.

In some embodiments, referring to FIG. 5, a surface of the anode electrode plate 211 facing away from the plurality of first protrusions 2113 is provided with a plurality of first recesses 2114, along the first direction X.

Both the first protrusions 2113 and the first recesses 2114 can disperse stress in the curved anode electrode plate 211, further facilitating suppression of deformation and rebound of the anode electrode plate 211, thereby further addressing the issues of reduced curvature and flattening deformation in the electrode assembly 20 and the entire secondary battery 100.

In some embodiments, referring to FIG. 5, an orthographic projection of the first protrusion 2113 overlaps with an orthographic projection of the first recess 2114, which is beneficial to further enhancing the suppression of deformation and rebound of the anode electrode plate 211.

In some embodiments, an orthographic projection of one first protrusion 2113 may overlap with an orthographic projection of one first recess 2114, or an orthographic projection of each first protrusion 2113 may overlap with an orthographic projection of one first recess 2114.

When an orthographic projection of one first protrusion 2113 overlaps with an orthographic projection of one first recess 2114 along the first direction X, it is beneficial to simultaneously forming the first protrusion 2113 and first recess 2114 whose orthographic projections overlap, thereby improving the processing efficiency of the first protrusions 2113 and first recesses 2114.

In other embodiments, an orthographic projection of one first protrusion 2113 may overlap with orthographic projections of multiple first recesses 2114, or an orthographic projection of one first recess 2114 may overlap with orthographic projections of multiple first protrusions 2113.

In some embodiments, referring to FIG. 6, a surface of the cathode electrode plate 212 is provided with a plurality of second protrusions 2123, where the second protrusions 2123 can disperse stress in the curved cathode electrode plate 212, suppressing deformation and rebound of the cathode electrode plate 212.

In some embodiments, referring to FIG. 6, a surface of the cathode electrode plate 212 facing away from the plurality of second protrusions 2123 is provided with a plurality of second recesses 2124.

Both the second protrusions 2123 and the second recesses 2124 can disperse stress in the curved cathode electrode plate 212, further facilitating suppression of deformation and rebound of the cathode electrode plate 212.

In some embodiments, along the first direction X, an orthographic projection of each second protrusion 2123 overlaps with an orthographic projection of one second recess 2124, which is beneficial to further enhancing the suppression of deformation and rebound of the cathode electrode plate 212.

In some embodiments, an orthographic projection of one second protrusion 2123 may overlap with an orthographic projection of one second recess 2124, or an orthographic projection of each second protrusion 2123 may overlap with an orthographic projection of one second recess 2124.

When an orthographic projection of one second protrusion 2123 overlaps with an orthographic projection of one second recess 2124 along the first direction X, it is beneficial to simultaneously forming the second protrusion 2123 and second recess 2124 whose orthographic projections overlap, thereby improving the processing efficiency of the second protrusions 2123 and second recesses 2124.

In other embodiments, an orthographic projection of one second protrusion 2123 may overlap with orthographic projections of multiple second recesses 2124, or an orthographic projection of one second recess 2124 may overlap with orthographic projections of multiple second protrusions 2123.

This is also beneficial to simultaneously forming the second protrusions 2123 and second recesses 2124, thereby improving the processing efficiency of the second protrusions 2123 and second recesses 2124.

In some embodiments, the anode electrode plate 211 forms the first protrusions 2113 and first recesses 2114 through an embossing process.

In some embodiments, the cathode electrode plate 212 forms the second protrusions 2123 and second recesses 2124 through an embossing process.

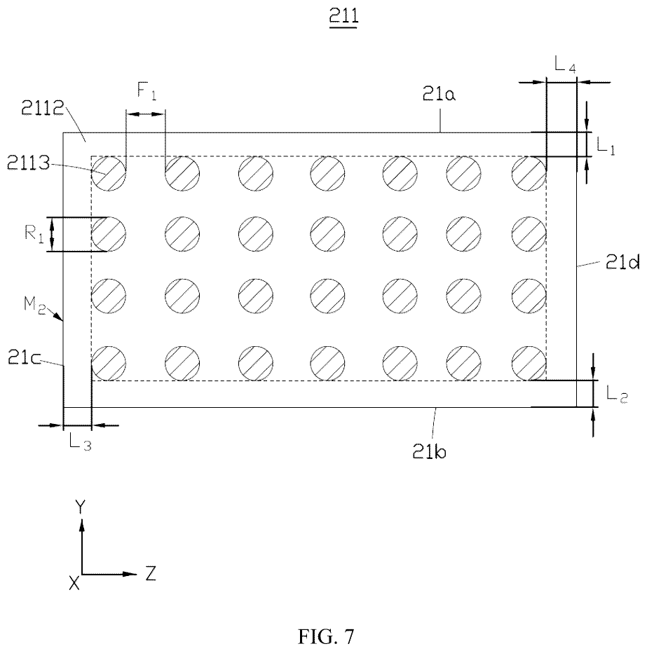

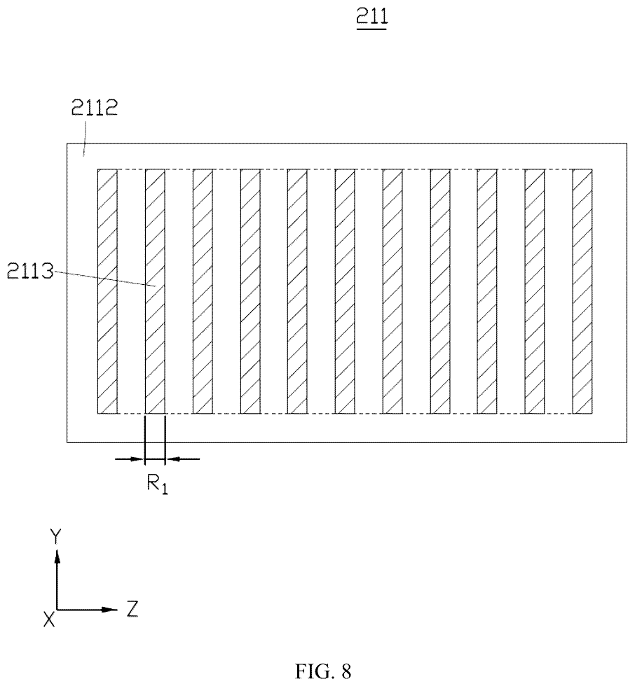

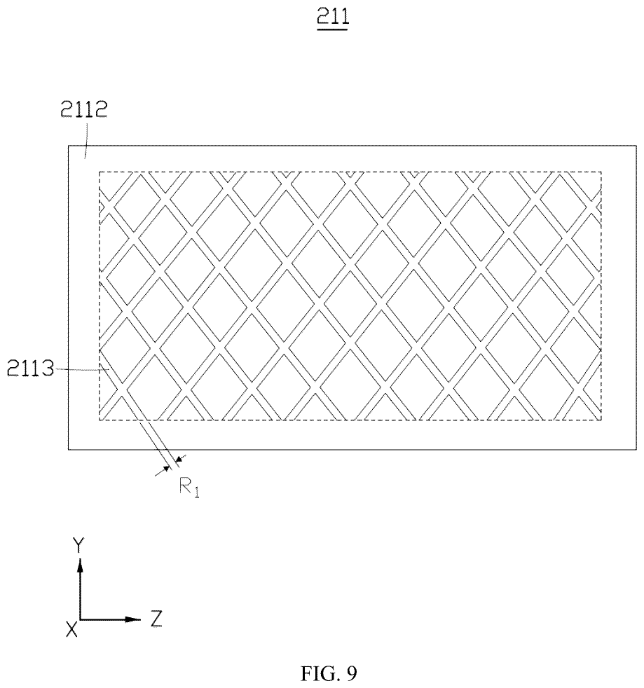

In some embodiments, referring to FIG. 7 to FIG. 9, a shape of the first protrusion 2113 is one of a dotted protrusion, a textured protrusion, or a striped protrusion.

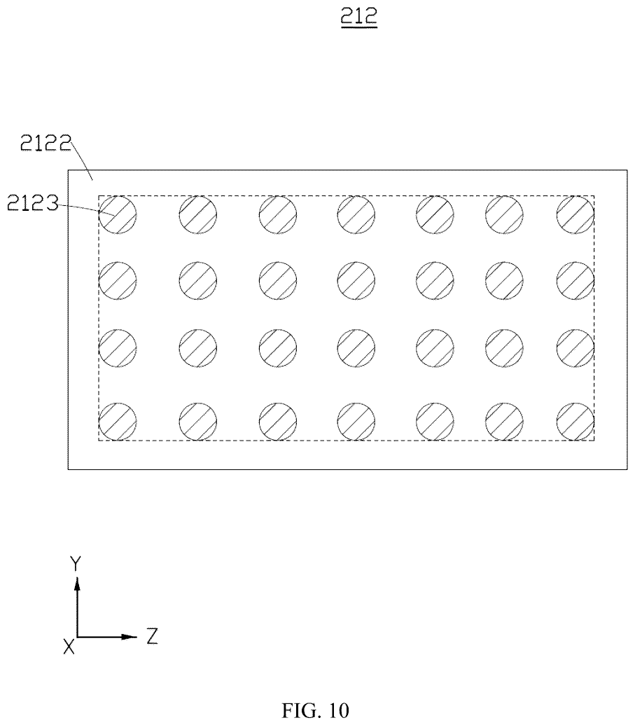

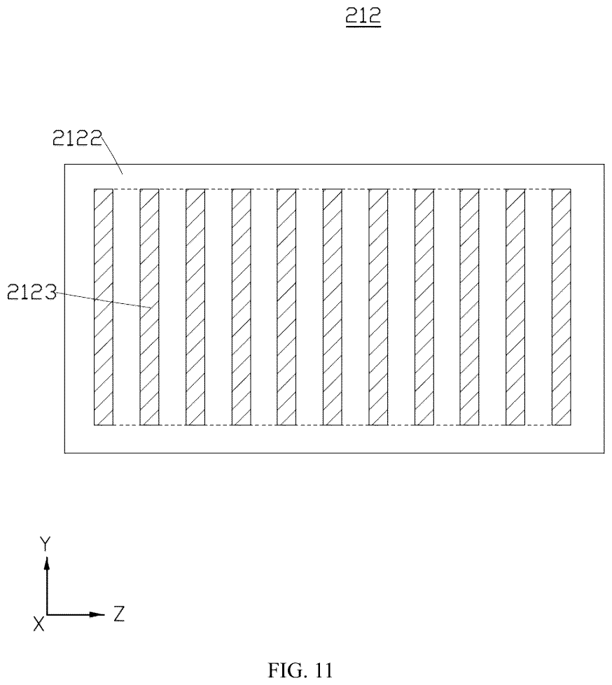

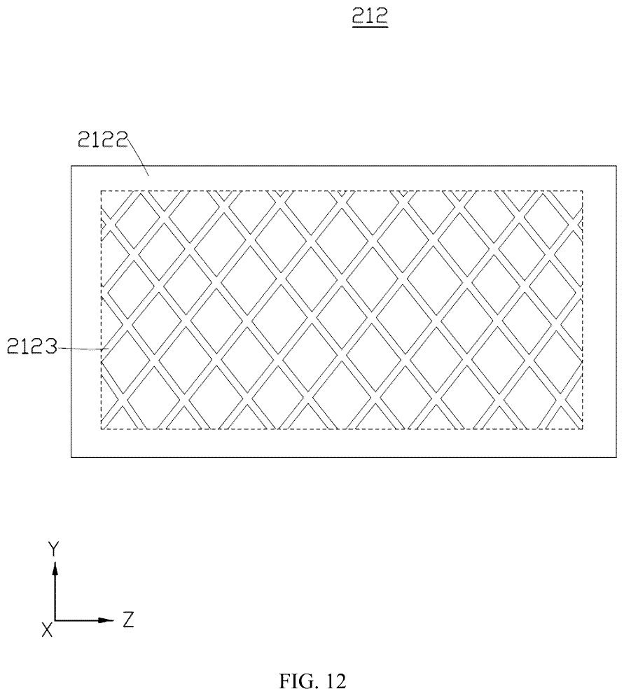

In some embodiments, referring to FIG. 10 to FIG. 12, a shape of the second protrusion 2123 is one of a dotted protrusion, a textured protrusion, or a striped protrusion.

In some embodiments, referring to FIG. 7 to FIG. 12, the shape of the first protrusion 2113 is different from the shape of the second protrusion 2123, which is beneficial to increasing the friction between the cathode electrode plate 212, the anode electrode plate 211, and the separator 22, thereby reducing the risk of slippage between the cathode electrode plate 212, the anode electrode plate 211, and the separator 22, and further enhancing the reliability of the electrode assembly 20.

In some embodiments, the shape of the first protrusion 2113 matches the shape of the second protrusion 2123, which is beneficial to allowing the first protrusion 2113 to be at least partially embedded in the second recess 2124, or allowing the second protrusion 2123 to be at least partially embedded in the first recess 2114, thereby further increasing the friction between the cathode electrode plate 212, the anode electrode plate 211, and the separator 22, reducing the risk of slippage between the cathode electrode plate 212, the anode electrode plate 211, and the separator 22, and further enhancing the reliability of the electrode assembly 20.

The following describes the anode electrode plate 211 and the first protrusions 2113 on the anode electrode plate 211. The specific configuration of the cathode electrode plate 212, the specific configuration of the second protrusions 2123, and their beneficial effects can refer to the specific embodiments and beneficial effects described below for the anode electrode plate 211 and the first protrusions 2113, and are not repeated here.

In some embodiments, referring to FIG. 7, in a flattened state of the anode electrode plate 211, when viewed along the first direction X, a sum of areas of the plurality of first protrusions 2113 is M₁ and an area of the anode electrode plate 211 is M₂, satisfying: 0.06M₂≤M₁<M₂. Satisfying this condition is beneficial to enhancing the stress dispersion effect of the plurality of first protrusions 2113 on the overall stress of the anode electrode plate 211, thereby improving the suppression of deformation of the first electrode plate 21 after curving.

In some embodiments, referring to FIG. 5, a thickness of the anode electrode plate 211 corresponding to the first coated region 211c is T₁ and a height of the first protrusion 2113 is H₁, satisfying H₁≤0.1T₁. Satisfying this condition is beneficial to enhancing the stress dispersion effect of the first protrusion 2113 on the anode electrode plate 211, thereby further suppressing deformation of the curved anode electrode plate 211. In embodiments where the first protrusion 2113 is formed by an embossing roller, satisfying this condition also helps reduce the risk of damage to the anode electrode plate 211 due to excessive pressure from the embossing roller or excessive local deformation of the anode electrode plate 211.

The thickness T₁ of the first coated region 211c of the anode electrode plate 211 is the sum of the thicknesses of the first current collector 2111, the first active material layer 2112 on the first side 211a, and the first active material layer 2112 on the second side 211b. The height H₁ of the first protrusion 2113 refers to the height of the tallest one among the plurality of first protrusions 2113.

In some embodiments, referring to FIG. 7, in a flattened state of the anode electrode plate 211, the anode electrode plate 211 has a first boundary line 21a and a second boundary line 21b oppositely disposed along the second direction Y, and a third boundary line 21c and a fourth boundary line 21d oppositely disposed along the third direction Z, where the first direction X, the second direction Y, and the third direction Z are pairwise perpendicular.

The first direction X is parallel to the thickness direction of the anode electrode plate 211, one of the second direction Y and the third direction Z is parallel to the width direction of the anode electrode plate 211, and the other is parallel to the length direction of the anode electrode plate 211.

In some embodiments, referring to FIG. 7, a minimum distance between the plurality of first protrusions 2113 and the first boundary line 21a is L₁, and a minimum distance between the plurality of first protrusions 2113 and the second boundary line 21b is L₂, satisfying 1 mm≤L₁≤7 mm and 1 mm≤L₂≤7 mm, which is beneficial to reducing the risk of the embossing roller pressing on the cut edges of the anode electrode plate 211 in the second direction Y, thereby reducing the risk of damage to the anode electrode plate 211.

As an exemplary illustration, L₁ may specifically be 1 mm, 2 mm, 3 mm, 4 mm, 5 mm, 6 mm, or 7 mm. L₂ may specifically be 1 mm, 2 mm, 3 mm, 4 mm, 5 mm, 6 mm, or 7 mm.

In some embodiments, referring to FIG. 7, a minimum distance between the plurality of first protrusions 2113 and the third boundary line 21c is L₃, and a minimum distance between the plurality of first protrusions 2113 and the fourth boundary line 21d is L₄, satisfying 1 mm≤L₃≤7 mm and 1 mm≤L₄≤7 mm, which is beneficial to reducing the risk of the embossing roller pressing on the cut edges of the anode electrode plate 211 in the third direction Z, thereby reducing the risk of damage to the anode electrode plate 211.

As an exemplary illustration, L₃ may specifically be 1 mm, 2 mm, 3 mm, 4 mm, 5 mm, 6 mm, or 7 mm and L₄ may specifically be 1 mm, 2 mm, 3 mm, 4 mm, 5 mm, 6 mm, or 7 mm.

In some embodiments, referring to FIG. 7, a distance between any two adjacent first protrusions 2113 is F₁, satisfying 1.5 mm≤F₁≤3 mm. Satisfying this condition is beneficial to dispersing stress in the anode electrode plate 211, further suppressing deformation of the curved anode electrode plate 211, and preventing the electrode assembly 20 from easily developing dark spots.

As an exemplary illustration, F₁ may specifically be 1.5 mm, 1.7 mm, 1.9 mm, 2 mm, 2.3 mm, 2.5 mm, 2.7 mm, 2.9 mm, or 3 mm.

In some embodiments, referring to FIG. 7, when viewed along the first direction X, a width of the first protrusion 2113 is R₁, satisfying R₁≥1 mm. Satisfying the condition R₁>1 mm is beneficial to enhancing the stress dispersion effect of the first protrusion 2113 on the anode electrode plate 211, thereby further suppressing deformation of the curved anode electrode plate 211, and preventing the electrode assembly 20 from easily developing dark spots.

As an exemplary illustration, R₁ may specifically be 1 mm, 1.2 mm, 1.5 mm, 2 mm, 2.3 mm, 2.5 mm, 2.7 mm, 2.9 mm, or 3 mm.

It can be understood that when the first protrusion 2113 is a dotted protrusion, the first protrusion 2113 is circular, and the width R of the first protrusion 2113 is the diameter of the first protrusion 2113. When the first protrusion 2113 is a striped protrusion, the length direction of the first protrusion 2113 is the extension direction of the striped protrusion, the width direction of the first protrusion 2113 is the arrangement direction of the plurality of first protrusions 2113, and the width R of the first protrusion 2113 is the width of the first protrusion 2113 along the arrangement direction. When the first protrusion 2113 is a textured protrusion, a single first protrusion 2113 is actually a slanted striped protrusion, the length direction of the first protrusion 2113 is the extension direction of the striped protrusion, the width direction of the first protrusion 2113 is the arrangement direction of the plurality of first protrusions 2113, and the width R of the first protrusion 2113 is the width of the first protrusion 2113 along the arrangement direction.

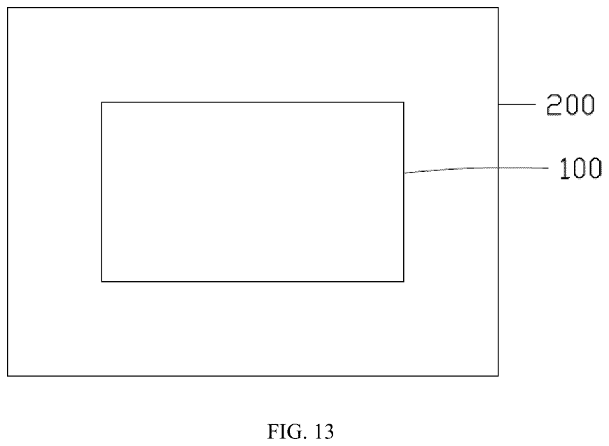

Referring to FIG. 13, an embodiment of the present application also provides an electronic apparatus 1000, where the electronic apparatus 1000 includes the secondary battery 100 according to any one of the above embodiments.

In some embodiments, the electronic apparatus 1000 may be a head-mounted device such as AR glasses or VR glasses, and is not listed exhaustively here.

In some embodiments, referring to FIG. 13, the electronic apparatus 1000 further includes an apparatus body 200, and the secondary battery 100 is installed in the apparatus body 200. Since the electronic apparatus 1000 adopts the technical solution of the secondary battery 100 according to any one of the above embodiments, it at least has the beneficial effects brought by the technical solution of any one of the embodiments of the secondary battery 100, which are not repeated here.

Additionally, those of ordinary skill in the art should recognize that the above embodiments are merely used to illustrate the present application and are not intended to limit the present application. Any appropriate modifications and variations made to the above embodiments within the essential scope of the present application fall within the scope disclosed by the present application.

What is claimed is:

1. A secondary battery comprising:
a housing and an electrode assembly, wherein the housing accommodates the electrode assembly and the electrode assembly is configured to be curved in a first direction;
wherein the electrode assembly comprises a cathode electrode plate, a separator, and an anode electrode plate arranged in a stacked manner;
the separator comprises a first surface and a second surface oppositely disposed along the first direction, the separator comprises a first adhesive layer disposed on the first surface and a second adhesive layer disposed on the second surface, the first adhesive layer adheres to the anode electrode plate, the second adhesive layer adheres to the cathode electrode plate, a peel strength between the first adhesive layer and the anode electrode plate is S₁, and a peel strength between the second adhesive layer and the cathode electrode plate is S₂, wherein S₁<S₂.

2. The secondary battery according to claim 1, wherein a surface of the anode electrode plate is provided with a plurality of first protrusions.

3. The secondary battery according to claim 1, wherein 1.6S₁≤S₂≤4S₁.

4. The secondary battery according to claim 1, wherein 6 N/m≤S₁<9.6 N/m.

5. The secondary battery according to claim 1, wherein 9.6 N/m≤S₂≤15 N/m.

6. The secondary battery according to claim 2, wherein a surface of the anode electrode plate facing away from the plurality of first protrusions is provided with a plurality of first recesses; and along the first direction, an orthographic projection of each first protrusion overlaps with an orthographic projection of a corresponding first recess from the plurality of recesses.

7. The secondary battery according to claim 6, wherein a surface of the cathode electrode plate is provided with a plurality of second protrusions, a surface of the cathode electrode plate facing away from the plurality of second protrusions is provided with a plurality of second recesses; and along the first direction, an orthographic projection of each second protrusion overlaps with an orthographic projection of a corresponding second recess from the plurality of second recesses.

8. The secondary battery according to claim 7, wherein a shape of the first protrusion is one of a dotted protrusion, a textured protrusion, or a striped protrusion;
and/or a shape of the second protrusion is one of a dotted protrusion, a textured protrusion, or a striped protrusion.

9. The secondary battery according to claim 2, wherein in a flattened state of the anode electrode plate, when viewed along the first direction, a sum of areas of the plurality of first protrusions is M₁ and an area of the anode electrode plate is M₂, satisfying: 0.06M₂≤M₁<M₂.

10. The secondary battery according to claim 1, wherein along the first direction, the anode electrode plate, the separator, and the cathode electrode plate are sequentially stacked to form a laminated structure; and in the first direction, outermost layers of the electrode assembly are both the cathode electrode plate.

11. The secondary battery according to claim 2, wherein along the first direction, the anode electrode plate, the separator, and the cathode electrode plate are sequentially stacked to form a laminated structure; and in the first direction, outermost layers of the electrode assembly are both the cathode electrode plate.

12. The secondary battery according to claim 3, wherein along the first direction, the anode electrode plate, the separator, and the cathode electrode plate are sequentially stacked to form a laminated structure; and in the first direction, outermost layers of the electrode assembly are both the cathode electrode plate.

13. The secondary battery according to claim 4, wherein along the first direction, the anode electrode plate, the separator, and the cathode electrode plate are sequentially stacked to form a laminated structure; and in the first direction, outermost layers of the electrode assembly are both the cathode electrode plate.

14. The secondary battery according to claim 5, wherein along the first direction, the anode electrode plate, the separator, and the cathode electrode plate are sequentially stacked to form a laminated structure; and in the first direction, outermost layers of the electrode assembly are both the cathode electrode plate.

15. The secondary battery according to claim 10, wherein the housing is an aluminum-plastic film packaging bag.

16. The secondary battery according to claim 1, wherein the first adhesive layer comprises a first adhesive, the second adhesive layer comprises a second adhesive; and the first adhesive and the second adhesive are each independently selected from one or a combination of polyvinylidene fluoride, vinylidene fluoride-hexafluoropropylene copolymer, polyamide, polyacrylonitrile, polyacrylate, polyacrylic acid, polyacrylate salt, polyvinylpyrrolidone, polyvinyl ether, polymethyl methacrylate, polytetrafluoroethylene, and polyhexafluoropropylene.

17. The secondary battery according to claim 16, wherein the first adhesive and the second adhesive are of a same type, and a content of the second adhesive in the second adhesive layer is greater than a content of the first adhesive in the first adhesive layer.

18. An electronic apparatus comprising:
a secondary battery comprising a housing and an electrode assembly, wherein the housing accommodates the electrode assembly and the electrode assembly is configured to be curved in a first direction;
wherein the electrode assembly comprises a cathode electrode plate, a separator, and an anode electrode plate arranged in a stacked manner;
the separator comprises a first surface and a second surface oppositely disposed along the first direction, the separator comprises a first adhesive layer disposed on the first surface and a second adhesive layer disposed on the second surface, the first adhesive layer adheres to the anode electrode plate, the second adhesive layer adheres to the cathode electrode plate, a peel strength between the first adhesive layer and the anode electrode plate is S₁, and a peel strength between the second adhesive layer and the cathode electrode plate is S₂, wherein S₁<S₂.

19. The electronic apparatus according to claim 18, wherein a surface of the anode electrode plate is provided with a plurality of first protrusions.
